(19) United States
(12) Patent Application Publication
(10) Pub. No.: US 2012/0316772 A1
(43) Pub. Date: Dec. 13, 2012

(54) NAVIGATION SYSTEM AND METHOD FOR PLANNING ROUTE THEREOF

(75) Inventors: Jie-Cai Han, Nanjing (CN); Kang-Jun Wan, Nanjing (CN)

(73) Assignees: INVENTEC APPLIANCES (PUDONG) CORPORATION, Shanghai (CN); INVENTEC APPLIANCES (JIANGNING) CORPORATION, Nanjing (CN); INVENTEC APPLIANCES CORP., New Taipei City (TW)

(21) Appl. No.: 13/494,711

(22) Filed: Jun. 12, 2012

(30) Foreign Application Priority Data
Jun. 13, 2011 (CN) 201110172619.7

(51) Int. Cl. G01C 21/34

(52) U.S. Cl. 701/414

(57) ABSTRACT

The invention discloses a navigation system and a method for planning a route thereof. The navigation system includes a storage unit and a processing unit. A cloud database of a cloud server and a local database of the navigation system are allocated in the storage unit, which is configured to store road condition data. The processing unit is connected to the storage unit, and generates an initial route according to an initial location and a destination. The processing unit also compares, computes and analyses the initial route and the road condition data, corresponding to at least one road section of the initial route, stored in the storage unit to generated a plurality of reference routes. Next, one of the reference routes is selected as a final route.

### CROSS-REFERENCE TO RELATED APPLICATION

This application claims the priority benefit of China application serial no. 201110172619.7, filed on Jun. 13, 2011. The entirety of the above-mentioned patent application is hereby incorporated by reference herein and made a part of this specification.

### BACKGROUND

1. Field of the Invention

The invention relates to a navigation system and a method for planning a route thereof, and, in particular, relates to a navigation system utilizing a data sharing mechanism of a cloud database and the method for planning a route thereof.

2. Description of Related Art

With popularization of using mobile devices and application developments of wireless networks, functionalities associated with Global Positioning Systems (GPS) or satellite positioning systems are continuously added into various kinds of mobile devices such as smart phones, personal digital assistants or tablet PC and so like. These mobile devices make it convenient for users accessing real-time activity route or information external to the activity range at any time. However, when the users utilize navigation functions of the mobile devices, the users may usually encounter problems of being unable to drive by following the route planned by the navigation system because of road damages, road maintenance, temporary road restriction or road congestion. Since the route provided by the navigation system is not suitable for practical requirements of the user, satisfaction of utilizing the navigation system is thus lowered.

Currently, there are navigation systems combining real-time road condition information to perform planning real-time road condition, such as Radio Data System-Traffic Message Channel (RDS-TMC) system. The RDS-TMC system obtains information of all locations with undesired road conditions through a remote server which is used for storing road conditions so as to plan a route by excluding road sections with such undesired road conditions, and then perform calculations to obtain the route having the shortest traveling time between two locations. However, the approach adopted by the RDS-TMC system downloads all undesired road condition information at once. Since the undesired road condition information has great amount and is complex to calculate, downloading all of the road condition information at once may result in long transmission time. As such, the navigation system cannot obtain the road condition information in a real-time manner, and then the users cannot exclude the road sections with undesired road conditions in time. Further, the RDS-TMC system is a sub-carrier broadcast system which is limited to particular carrier frequencies. Thus, the problems of being unable to obtain the undesired road condition data may occur quite often due to incapable of receiving the communication, and this further lowers practicality of the RDS-TMC system.

Further, navigation devices can analyse all possible suggested routes through the remote server, compare road condition information of the suggested routes, and then transmit back the road condition information corresponding to the suggested routes so as to achieve an objective of unnecessary downloading all road condition information at once. However, such approach may increase waiting time of downloading the road condition information due to calculation in advance through the remote server. Additionally, when the remote server has abnormal condition or system crashes, the user cannot download the road condition information.

### SUMMARY

In view of the aforementioned problems of the conventional art, the invention is directed to a navigation system and a method for planning a route thereof. Through a data sharing mechanism of a cloud database, and operations of a local device performing a road condition analysis to generate a reference route, waiting time of downloading the road condition information can be shortened, and complexity and the amount of data required for downloading the road condition information can also be lowered.

According to one of objectives of the invention, there is proposed a navigation system. The navigation system includes a storage unit and a processing unit. The storage unit comprises a cloud server and a local database of the navigation system. The storage unit is configured to store road condition data. The road condition data at least includes a plurality of first average travelling speeds, a plurality of first standby durations, a plurality of first road condition information or a plurality of historical navigation records. The processing unit is connected to the storage unit, and configured to generate an initial route according to an initial location and a querying destination. Also, the processing unit is further configured to compare, compute and analyse the initial route and the road condition data, corresponding to at least one road section of the initial route stored in the storage unit to generate a plurality of reference routes. Then, one of the reference routes is selected to be a final route.

According to an embodiment of the invention, upon the navigation system performing a navigation operation according to the final route, the processing unit is further configured to obtain a second average travelling speed, second standby duration or second road condition information through computation and analysis. The processing unit is configured to transmit the second average travelling speed, the second standby duration or the second road condition information to the storage unit.

According to an embodiment of the invention, the reference routes are sorted by the processing unit based on estimated travelling durations respectively corresponding to the reference routes, and then one of the reference routes having a shortest estimated travelling duration is selected to be a most prioritized reference route. Also, the navigation system includes a displaying unit configured to display these reference routes for a user to select the final route.

According to an embodiment of the invention, upon the processing unit transmitting the second average travelling speed, the second standby duration or the second road condition information to the storage unit, the processing unit further transmits a confirmation message to confirm that the second average travelling speed, the second standby duration or the second road condition information is transmitted to the cloud database or the local database. Also, the cloud database provides data shared by a plurality of users.

According to an embodiment of the invention, there is proposed a method for planning a route in a navigation system. The navigation system includes a storage unit and a processing unit. The method for planning a route in a navigation system includes following steps. An initial route is generated at the processing unit based on an initial location and a destination. Road condition data, corresponding to at least one road section of the initial route, stored in the storage unit is accessed. The road condition data includes a first average travelling speed, first standby duration, road condition information or a historical navigation record. A plurality of reference routes is generated at the processing unit by comparing, computing and analysing the initial route and the road condition data. One of the reference routes is selected at the processing unit to be a final route. Upon the navigation system performing a navigation operation according to the final route, the processing unit obtains a second average travelling speed, a second standby duration or a second road condition information through computation and analysis, and transmits the second average travelling speed, the second standby duration and the second road condition information from the processing unit to the storage unit.

According to an embodiment of the invention, the method further includes following steps. The reference routes are sorted at the processing unit based on estimated travelling durations respectively corresponding to the reference routes. One of the reference routes having a shortest estimated travelling duration is selected at the processing unit to be a most prioritized reference route. The reference routes are displayed at one displaying unit of the navigation system for a user to select the final route.

According to an embodiment of the invention, the storage unit includes a cloud database of a cloud server and a local database of the navigation system, and the cloud database provides data shared by a plurality of users. Also, the method further includes following steps. Upon transmitting the second average travelling speed, the second standby duration or the second road condition information from the processing unit to the storage unit, a confirmation message is transmitted at the processing unit to confirm that the second average travelling speed, the second standby duration or the second road condition information is transmitted to the cloud database or the local database.

Based upon the aforementioned descriptions, according to embodiments of the navigation system and the method for planning a route in the navigation system of the invention, the invention may have an advantage or a plurality of advantages illustrated below.

(1) The navigation system can be achieved by expanding functionalities of the current commonly adapted navigation devices with computation, analysis, data uploading, data downloading and combined records. Thus application simplicity is enhanced, utilization rate is increased and cost of the navigation system is lowered.

(2) Through data sharing mechanism of the cloud database, the navigation system can quickly accumulate real and accurate road condition information to perform calculation on the combined information of the road condition, thereby enhancing relevance and practicality of route planning.

(3) Through accumulated data in the local database, the navigation system can avoid the problems of being unable to access the road condition information due to abnormal conditions of wireless communication.

(4) The method for planning a route in the navigation system can shorten waiting time of downloading the road condition information and the downloading time through accessing the road condition data corresponding to at least one road section of the initial route.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structure diagram of a navigation system according to an embodiment of the invention.

FIG. 2 is a schematic diagram of a navigation system according to a first embodiment of the invention.

FIG. 3 is a schematic diagram of a navigation system according to a second embodiment of the invention.

FIG. 4 is a flowchart illustrating a method for planning route of a navigation system according to a second embodiment of the invention.

### DETAILED DESCRIPTION OF DISCLOSED EMBODIMENTS

The navigation system and the method for planning a route in the navigation system of the invention will be illustrated in accordance with accompanying figures. To facilitate understanding, the same components in embodiments below will be labelled with the same figure numbers.

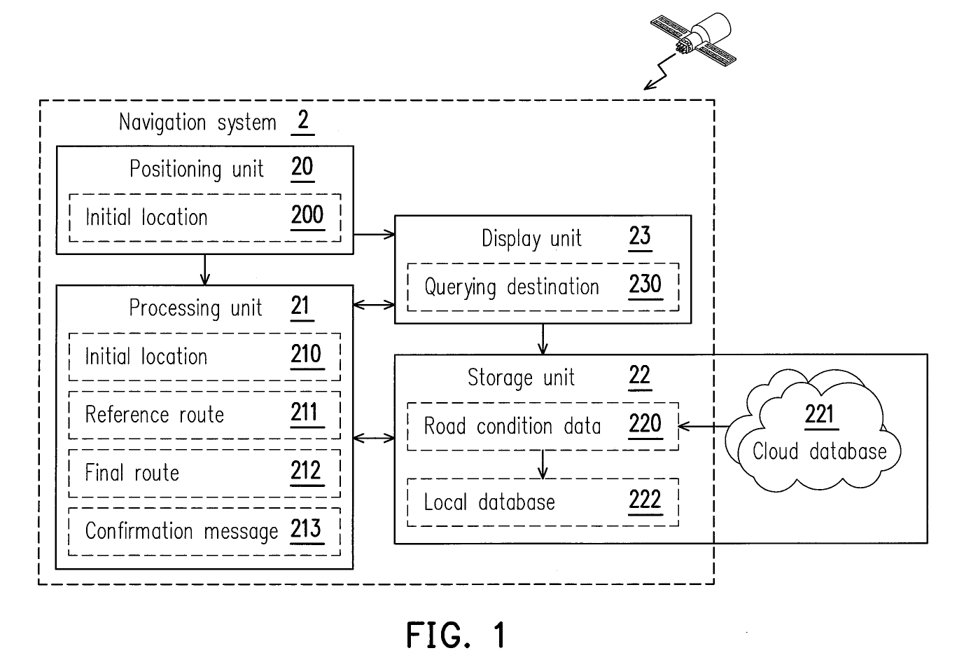

FIG. 1 is a schematic structure diagram of a navigation system according to an embodiment of the invention. As illustrated in FIG. 1, the navigation system 2 includes a positioning unit 20, a processing unit 21, a storage unit 22 and a displaying unit 23. The storage unit 22 may include a cloud database 221 allocated in the cloud server and a local database 222 allocated in the navigation system 2. The local database 222 may be a built-in internal memory or an externally connected memory card, such as a Compact Flash (CF) memory card, a Micro Drive (MD) memory card, a Secure Digital (SD) memory card, a Multi Media Card (MMC) memory card or so like, but the invention is not limited thereto. In the present embodiment, the storage unit 22 is configured to store road condition data 220. The road condition data 220 may at least include a plurality of first average travelling speeds, a plurality of first standby durations, a plurality of first road condition information or a plurality of historical navigation records. The first average travelling speeds, the first standby durations, the information of road condition and the historical navigation records may be generated by the navigation system 2 or other navigation systems (not shown).

The positioning unit 20 is connected to the processing unit 21 and the displaying unit 23, and is configured to perform real-time location searching, so as to position the current location of the user. Also, the positioning unit 20 is configured to transmit the current location to the processing unit 21, and may display the current location on the displaying unit 23. The displaying unit 23 may be a touch screen, which may accept operations or commands input by the user. The operations or commands may be used to set the operation modes, personal favourite settings or querying conditions of the navigation system 2. Alternatively, the user may directly input or set the operation modes, personal favourite settings or querying conditions of the navigation system 2 through keys of the mobile device or through voice command by voice recognition of the mobile device. The operations or the commands of the navigation system 2 may be set or input through hand-writing, pressing a key or voice input, but these approaches are merely examples of embodiments of the navigation system of the invention. People with ordinary skill in the field should understand the aforementioned input methods are not intended to limit the invention.

The processing unit 21 is connected to the storage unit 22, the positioning unit 20 and the displaying unit 23. The processing unit 21 is configured to generate an initial route 210 through planning procedure according to an initial location 200 provided by the positioning unit 20 and a querying destination 230 input by the user. Also, the processing unit 21 can search the cloud database 221 and the local database 222 at the same time, so as to determine whether the road condition data 220 corresponding to at least one section in the initial route 210 is stored in the storage unit 22. In the searching result, if the cloud database 221 stores the road condition data 220 corresponding to at least one section in the initial route 210, the processing unit 21 will download the road condition data 220. There may be multiple local databases 222 which are configured to store the road condition data 220, and the processing unit 21 will access the road condition data 220, and display the road condition data 220 on the displaying unit 23, so as to remind the user of the road section(s) with the road condition data 220. Also, the processing unit 21 may inform the user of detailed road condition information through the displaying unit 23. Additionally, the processing unit 21 compares the initial route 210 with the road condition data 220 obtained from the storage unit 22, and then computes and analyses on the comparison result to generate a plurality of reference routes 211.

Further, the processing unit 21 may sort the reference routes based on estimated travelling durations respectively corresponding to the reference routes 211, and then select one of the reference routes having a shortest estimated travelling duration to be a most prioritized reference route 211. Also, the processing unit 21 may display the reference routes 211 respectively on the displaying unit 23 according to their priorities for the user to select a final route 212 from these reference routes 211. When the user decides the final route 212, the positioning unit 20 may transmit a current real-time location 201 and a real-time time 202 to the processing unit 21. When the navigation system 2 completes the navigation process of the final route 212, the processing unit 21 performs computation and analysis on the real-time location 201 and the real-time time 202 to obtain the second average travelling speed, the second standby duration or the second road condition information. Additionally, the processing unit 21 may transmit the second average travelling speed, the second standby duration, or the second road condition information, and the navigation track and the navigation time of the instant operation to the storage unit 22, so as to update the road condition data 220 in the storage 22.

Further, when the processing unit 21 intends to transmit the second average travelling speed, the second standby duration, or the second road condition information and the current navigation track and the current navigation time to the storage unit 22 for updating the road condition data 220, the processing unit 21 may output a confirmation message 213 to confirm that the second average travelling speed, the second standby duration, or the second road condition information and the navigation track and the navigation time is transmitted to the cloud database 221 or the local database 222. Alternatively, the navigation system 2 may firstly store the aforementioned information in the local database 222, and then upload the aforementioned information to the cloud database 221 through a copy operation.

It is noted that the cloud database 221 may provide data shared by a plurality of users. Through the second average travelling speed, the second standby duration, the second road condition information and the current navigation track and the current navigation time provided by every user, the road condition data 220 in the cloud database 221 may be quickly updated. Thereby, the road condition data 220 can be made to be perfect, and the navigation system 2 can provide smarter reference route 211. Additionally, the multi-user data sharing mechanism may also enable the first time user to have sufficient road condition data 220 or the road condition statistics information.

In the present embodiment, the second average travelling speed, the second standby duration, the second road condition information, the current navigation track or the current navigation time may be uploaded without personal information of the user, so as to protect privacy of the user.

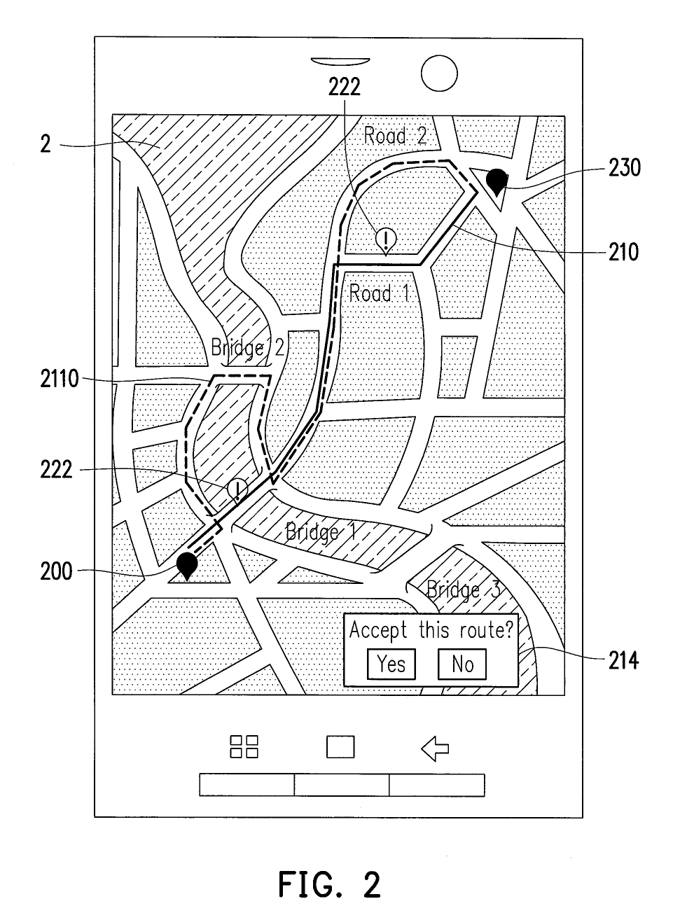

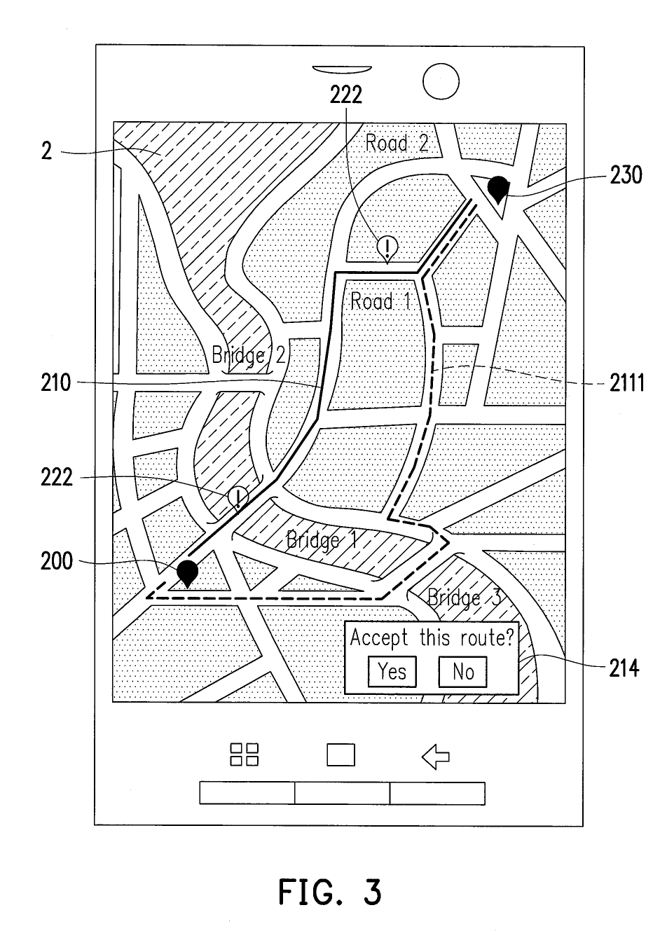

FIG. 2 is a schematic diagram of a navigation system according to a first embodiment of the invention. FIG. 3 is a schematic diagram of a navigation system according to a second embodiment of the invention. In view of the aforementioned descriptions, referring to both FIG. 2 and FIG. 3, the navigation system 2 may be applied on smart phones, tablet PCs or satellite navigation devices. After entering the navigation screen, the user may input the querying destination 230 to make the navigation system start planning a navigation route. At this instant, the positioning unit 20 may position the initial location 200 of the user, and report a longitude value and a latitude value of the initial location 200 to the processing unit 21. Thus, the processing unit 21 may generate the initial route 210, as shown with solid lines in the FIGS. 2 and 3, according to the initial location 200 and the querying destination 230. Also, the processing unit 21 may search through the cloud database 221 and the local database 222 to determine whether the road condition data 220 corresponding to at least one road section in the initial route 210 is stored in the storage unit 22.

If it is determined that the road condition data 220 corresponding to at least one road section in the initial route 210 is not stored in the storage unit 22, then the processing unit 21 sets the initial route 210 to be the final route 212, and then starts navigation process.

Further, if it is determined that the road condition data 220 corresponding to at least one road section in the initial route 210 is stored in the storage unit 22, then the displaying unit 23 may display the road section with the road condition data. In the simulation figures, the bridge 1 and the road 1 are set to be road section with undesired road conditions, such as restrictions, maintenance or congestions. Thus, the road section of the bridge 1 and the road 1 may be marked by notifying icons such as exclamation marks. The user in the present embodiment may click these notifying icons 222 to further understand the road condition information of the bridge 1 and the road 1.

Further, the processing unit 21 may analyse and make assessments on the road condition data 220 of the bridge 1 and the road 1 to exclude the bridge 1 and the road 1 with the road conditions. The processing unit 21 may generate a first reference route 2110 with a bridge 2 and a road 2, as shown with dotted lines in the FIG. 2, for the user. The user may determine to accept the first reference route 2110 provided by the navigation system 2 after thoroughly understanding the road condition information in detail. If the user decides to accept the first reference route 2110, then the user may press a Yes key in the querying message 214 to confirm that the first reference route 2110 is accepted as the final route 212. If the user decides not to accept the first reference route 2110, then the user may press a No key in the querying message 214, and thus the processing unit 21 has to provide a second reference route 2111, as shown in the FIG. 3.

At this moment, the processing unit 21 may generate again the second reference route 2111 with a bridge 3 based on the initial location 200, the road condition data 220 and the querying destination 230, where the second reference route 2111 excludes the bridge 1 and the road 1. Similarly, if the user decides not to adopt the second reference route 2111 provided by the navigation system 2 to be the final route 212, the processing unit 21 may respectively provide the reference routes 211 having shorter estimated travelling durations to the user until the user decides the final route 212.

It is noted that the method for planning the reference routes 211 may be configured to only exclude the road section(s) with road conditions, and still maintains travelling on the road section of the initial route 210 such as the first reference route 2110. Alternatively, it may be configured to plan a travelling route between the initial location 200 and the querying destination 230 such as the second reference route 2111. However, people with ordinary skill in the field should understand the aforementioned method for planning route are only the examples of the embodiments of the navigation system of the invention, but they are not intended to limit the invention.

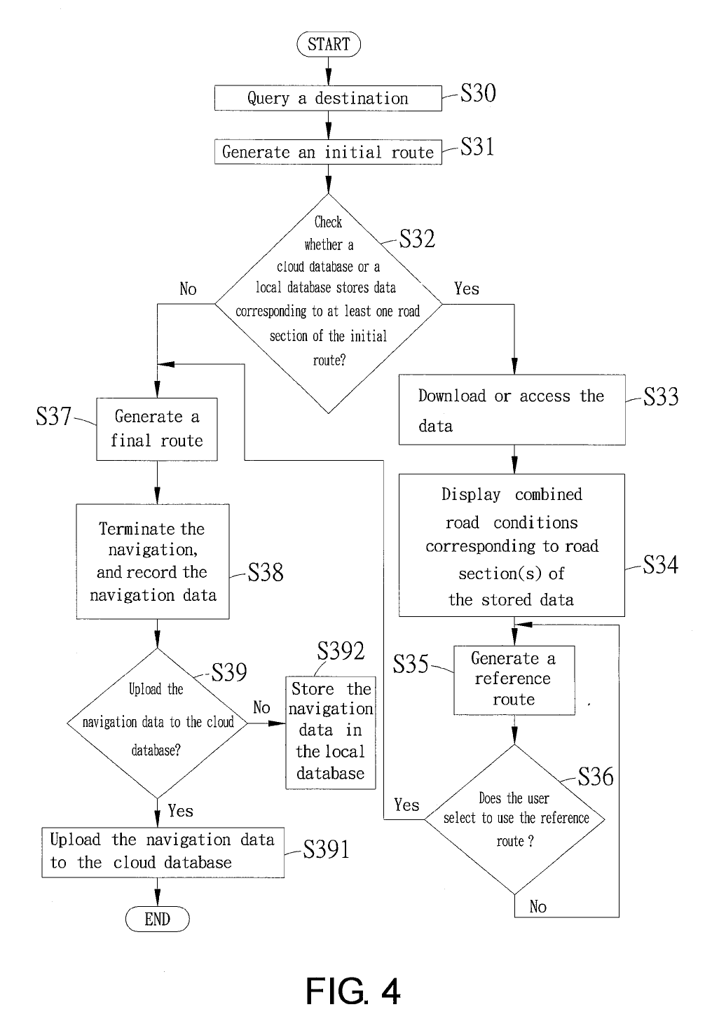

FIG. 4 is a flowchart illustrating a method for planning a route of a navigation system according to a second embodiment of the invention. Referring to FIG. 4, the navigation system may include a positioning unit, a processing unit, a storage unit and a displaying unit. As illustrated in FIG. 4, when the user starts using the navigation system, the displaying unit may display a welcome screen and enters the navigation screen. In step S30, the user may enter a destination to query a travelling route to the destination.

In step S31, the positioning unit transmits the initial location to the processing unit, and the processing unit may generate the initial route according to the initial location and the destination.

Meanwhile, in step S32, the processing unit may search through the cloud database and the local database to check whether the road condition data corresponding to at least one road section of the initial route is stored in the storage unit. In the search result, if it is determined that the road condition data is stored in the cloud database or the local database, then step S33 is executed after the step S32. In the step S33, the processing unit may respectively download or access the road condition data from the cloud database or the local database. If it is determined that the road condition data is not stored in the storage unit, the step S37 is executed after the step S32. In the step S37, the processing unit uses the initial route to generate the final route to perform the navigation process, and records the current real-time location and real-time time.

Step S34 is executed after the step S33. In the step S34, the displaying unit displays the road condition data corresponding to any road section of the initial route to remind the user of the road section(s) having road condition(s) and also notify the user of the detailed road condition information.

Next, in step S35, the processing unit compares, computes and analyses the initial route and the road condition data corresponding to any road section of the initial route to generate a plurality of reference routes. The processing unit may sorts each reference route according to its corresponding estimated travelling durations, and then select one reference route having the shortest estimated duration to be the most prioritized reference route. Also, the processing unit may respectively display the reference routes on the displaying unit for the user to select one reference route among the reference routes to be the final route. Step S36 is executed after the step S35. In the step S36, when the user decides to use one of the reference routes displayed on the displaying unit to perform the navigation process, then step S37 is executed. In step S37, the processing unit performs the navigation process according to the selected reference route and records the current real-time location and real-time time. When the user decides not to use the reference route displayed by the displaying unit to perform the navigation process, it returns to execute the step S35.

Step S38 is executed after the step S37. In the step S38, when the navigation system completes the navigation process of the final route, the processing unit computes and analyses on the real-time location and the real-time time to generate a second travelling speed, second standby duration or second road condition information.

Next, in step S39, the processing unit outputs a confirmation message to query the user whether to upload information such as the second travelling speed, the second standby duration or the second road condition information and the current navigation track and the current time to the cloud database in order to update the cloud database. If the user confirms that the information should be uploaded to the cloud database, step S391 is executed after the step S39. In the step S391, the processing unit uploads information of the second travelling speed, the second standby duration or the second road condition information and the current navigation track and the current time to the cloud database. If the user cancels or rejects uploading the information to the cloud database, then step S392 is executed after the step S39. In the step S392, the processing unit stores information such as the second travelling speed, the second standby duration or the second road condition information and the current navigation track and the current time to the local database.

Detailed descriptions and implementations of the method for planning route of navigation system of the invention are provided previously when illustrating the navigation system of the invention, and will not be repeated herein for briefness of illustration.

In summary, through accumulation and updating of road condition data in a local database, the navigation system and the method for planning route thereof can avoid the problem in which the road condition data of a cloud database cannot be accessed in a real-time manner due to abnormal situations of wireless communication. Also, through data sharing mechanism of the cloud database, real and accurate road condition information can be quickly accumulated to perform calculations on combined information of the road condition, thereby enhancing relevance and practicality of route planning.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A navigation system, comprising:
a storage unit, comprising a cloud database of a cloud server and a local database of the navigation system, configured for storing road condition data, wherein the road condition data at least comprises a plurality of first average travelling speeds, a plurality of first standby durations, a plurality of first road condition information or a plurality of historical navigation records; and
a processing unit, connected to the storage unit, configured to generate an initial route according to an initial location and a destination, and the processing unit further configured to compare, compute and analyse the initial route and the road condition data, corresponding to at least one road section of the initial route stored in the storage unit to generate a plurality of reference routes, and to select one of the reference routes to be a final route;
wherein, upon the navigation system performing a navigation operation according to the final route, the processing unit is further configured to obtain a second average travelling speed, second standby duration or second road condition information through computation and analysis, and the processing unit is configured to transmit the second average travelling speed, the second standby duration or the second road condition information to the storage unit.

2. The navigation system as claimed in claim 1, further comprising:
a displaying unit, configured for displaying the road condition data corresponding to the at least one road section of the initial route.

3. The navigation system as claimed in claim 2, wherein the processing unit sorts the reference routes based on estimated travelling durations respectively corresponding to the reference routes, and then selects one of the reference routes having a shortest estimated travelling duration to be a most prioritized reference route.

4. The navigation system as claimed in claim 3, wherein the displaying unit is configured for displaying the reference routes for a user to select the final route.

5. The navigation system as claimed in claim 1, wherein, upon the navigation system performing the navigation operation according to the final route, the processing unit records a real-time location and a real-time time in the storage unit; and, upon the navigation operation being completed, the processing unit performs computation and analysis on the real-time location and the real-time time to obtain the second average travelling speed, the second standby duration and the second road condition information.

6. The navigation system as claimed in claim 1, wherein, upon the processing unit transmitting the second average travelling speed, the second standby duration or the second road condition information to the storage unit, the processing unit further transmits a confirmation message for confirming that the second average travelling speed, the second standby duration or the second road condition information is transmitted to the cloud database or the local database.

7. The navigation system as claimed in claim 1, wherein the cloud database provides data shared by a plurality of users.

8. A method for planning a route in a navigation system, the navigation system comprising a storage unit and a processing unit, the method comprising:
generating, at the processing unit, an initial route based on an initial location and a destination;
accessing road condition data, corresponding to at least one road section of the initial route, stored in the storage unit, wherein the road condition data comprises a first average travelling speed, first standby duration, road condition information or a historical navigation record;
generating, at the processing unit, a plurality of reference routes by comparing, computing and analyzing the initial route and the road condition data;
selecting, at the processing unit, one of the reference routes to be a final route;
upon the navigation system performing a navigation operation according to the final route, the processing unit obtaining a second average travelling speed, a second standby duration or a second road condition information through computation and analysis, and
transmitting the second average travelling speed, the second standby duration and the second road condition information from the processing unit to the storage unit.

9. The method for planning a route in a navigation system as claimed in claim 8, further comprising:
displaying the road condition data on a displaying unit of the navigation system.

10. The method for planning a route in a navigation system as claimed in claim 9, further comprising:
sorting the reference routes, at the processing unit, based on estimated travelling durations respectively corresponding to the reference routes; and
selecting, at the processing unit, one of the reference routes having a shortest estimated travelling duration to be a most prioritized reference route.

11. The method for planning a route in a navigation system as claimed in claim 10, further comprising:
displaying the reference routes on the displaying unit for a user to select the final route from the reference routes.

12. The method for planning a route in a navigation system as claimed in claim 8, further comprising:
upon the navigation system performing the navigation operation according to the final route, the processing unit recording a real-time location and a real-time time in the storage unit; and
upon the navigation operation being completed, obtaining the second average travelling speed, the second standby duration and the second road condition information through the processing unit's computation and analysis on the real-time location and the real-time time.

13. The method for planning a route in a navigation system as claimed in claim 8, wherein the storage unit comprises a cloud database of a cloud server and a local database of the navigation system, and the method further comprises providing data shared by a plurality of user at the cloud database.

14. The method for planning a route in a navigation system as claimed in claim 13, further comprising:
upon transmitting the second average travelling speed, the second standby duration or the second road condition information from the processing unit to the storage unit, transmitting a confirmation message at the processing unit for confirming that the second average travelling speed, the second standby duration or the second road condition information is transmitted to the cloud database or the local database.
